(19) United States
(12) Patent Application Publication
(10) Pub. No.: US 2025/0234390 A1
(43) Pub. Date: Jul. 17, 2025

(54) METHOD FOR ENHANCEMENT OF PHYSICAL RANDOM ACCESS CHANNEL TRANSMISSION AND RECEPTION OF RANDOM ACCESS RESPONSE

(71) Applicant: Mavenir Systems, Inc., Richardson, TX (US)

(72) Inventors: Jianying Liu, Beijing (CN); Yan Wang, Beijing (CN); Fan Yang, Beijing (CN); Kuiyuan Li, Beijing (CN); Yan Lu, Beijing (CN); Miao Zhang, Beijing (CN)

(73) Assignee: Mavenir Systems, Inc., Richardson, TX (US)

(21) Appl. No.: 19/095,250

(22) Filed: Mar. 31, 2025

Related U.S. Application Data
(63) Continuation of application No. PCT/CN2022/123335, filed on Sep. 30, 2022.

(51) Int. Cl. H04W 74/0833; H04B 7/06; H04L 5/00

(52) U.S. Cl. CPC H04W 74/0833; H04B 7/06952; H04L 5/0044; H04L 5/0051

(57) ABSTRACT

A system and method for Physical Random Access Channel (PRACH) transmission and reception of Random Access (RA) response in New Radio (NR) network. A user equipment (UE) sends to a gNodeB (gNB), an N times Msg 1, on N consecutive Random Access Channel (RACH) Occasion (ROs) with a same Tx beam or a plurality of different Tx beams in a RA attempt; and after the N times transmissions, the UE starts an Random Access Response (RAR) window and monitors all N Random Access-Radio Network Temporary Identities (RA-RNTIs) to receive a network response. Upon successful reception of an RAR message, the UE determines a best transmission beam.

### CROSS REFERENCE TO RELATED APPLICATIONS

The present application is a continuation application of International (PCT) application No. PCT/CN2022/123335 filed on Sep. 30, 2022 and is incorporated herein by reference in entirety.

### BACKGROUND

### a. Field of the Disclosure

The present disclosure relates to systems and methods for radio access networks. The present disclosure also relates to the design of operation, administration and management of various network elements of 4G and 5G based mobile networks. The present disclosure further relates to CSI enhancements in mobile networks.

### b. Description of the Related Art

Coverage is one of the key factors that an operator considers when commercializing cellular communication networks due to its impact on service quality as well as capital expenditure and operating expenditure.

Compared to LTE, 5G NR is designed to operate at much higher frequencies such as 28 GHz or 39 GHz in FR2, or 3.5 GHz on FR1. Due to the higher frequencies, the wireless channel is subject to higher path-loss, making it more challenging to maintain an adequate quality of service that is at least equal to that of legacy RATs.

In the FR1 case, coverage is an issue as these spectrums can be designed to handle mobile services such as voice and low-rate data services. UL performance can be a bottleneck in many, if not most, scenarios for real deployment. Emerging vertical use cases have UL heavy traffic, such as, for example, video uploading.

Different PRACH formats are defined in specification 3GPP 38.211 [2]. These different PRACH formats determine the coverage range of PRACH. To improve the coverage range, in particular for FR2, which has only short formats, two possible methods are:
Multiple PRACH transmissions with the same UE Tx beam. This case can be called “PRACH repetition”.
Multiple PRACH transmissions with different UE Tx beams. This case can be called “PRACH sweeping”.

The above two methods can obtain received gain by the reception combination of multiple PRACH transmissions at which the gNB decodes msg1 so as to improve PRACH coverage range. For PRACH sweeping, the gNB can also indicate the optimal transmission beam to a UE for following Msg3 transmission.

A problem is that the gNB does not know which ROs needs to be received and combined and which ROs do not need to be combined. For example, legacy UE does not support PRACH repetition and PRACH sweeping, so the gNB does not need to combine some ROs. In addition, if the gNB needs to combine for enhanced UE, a problem is how to determine the locations of ROs, because the time for UE to initiate random access is different.

Another problem is how to indicate the best transmission beam to UE in a beam sweeping case.

### BRIEF DESCRIPTION OF THE DRAWINGS

FIG. 1 is a block diagram of a system architecture.

FIG. 2 shows an implementation of PRACH repetition/sweeping operations.

FIG. 3 shows another implementation of PRACH repetition/sweeping operations.

FIG. 4 shows an implementation of distinguishing legacy UEs and enhanced UEs.

FIG. 5 shows another implementation of distinguishing legacy UEs and enhanced UEs.

FIG. 6 shows MAC RAR format for indicating a best beam.

FIG. 7 shows an implementation of multiple Msg1 transmissions with same Tx beam.

FIG. 8 shows an implementation of multiple Msg1 transmissions with different Tx beams.

### SUMMARY

One or more aspects of the subject disclosure include a system, a device, a computer program product, and/or a non-transitory machine-readable medium, comprising executable instructions that, when executed by a processing system including a processor, executes the method(s) described herein.

In an implementation, described is a method comprising: providing a gNB with parameters the gNB employs to configure system information for a PRACH sweeping and repetition operation, the gNB parameters comprising:
a total number of PRACH repetition and sweeping,
a first RACH occasion index,
a RO interval and period,
a number of PRACH repetition, and
a number of PRACH sweeping.

In an implementation, the method can further comprise:
determining, using one or more of the parameters, the multiple ROs' location by the UE for the PRACH sweeping and repetition operation. The determination can comprise:
a RACH occasion index [m, n]=first RACH occasion index+n*period+m* the RO interval, where n is from 0,1,2 . . . to (┌total number of RO in PRACH period/period┐−1), m is from 0,1,2 . . . to (the total number of PRACH repetition and sweeping−1);
a RACH occasion index [m, n]=first RACH occasion index+n*period+m* RO interval, where n is from 0,1,2 . . . to (┌total number of RO in RO period/period┐−1), m is from 0,1,2 . . . to (the total number of PRACH repetition and sweeping−1), where the total number of PRACH repetition and sweeping is the number of PRACH repetition multiplied by the number of PRACH sweeping. A UE behavior for transmitting the Msg1 preamble for the PRACH sweeping and repetition operation can comprise, if configuration by the gNB is both PRACH sweeping and repetition:
the UE first performing a PRACH sweeping operation in a repetition and sweeping set, and if there are still available ROs, then repeating a previous transmission pattern; or
the UE first performing a number of PRACH repetition operations, next performing a number of PRACH sweeping operations, and if (i) the UE does not support PRACH sweeping or (ii) the number of beams is less than the number of PRACH sweeping operations, then repeating a previous transmission pattern.

In an implementation, the method can further comprise the UE behavior for transmitting a Msg1 preamble for the PRACH sweeping and repetition, the operation comprising, if configuration by the gNB is PRACH repetition, a UE performs only the PRACH repetition operation.

In an implementation, the method can further comprise: the UE behavior for transmitting a Msg1 preamble for the PRACH sweeping and repetition operation comprising, if configuration by the gNB is PRACH sweeping, the UE attempting PRACH sweeping, and if the number of beams less than the number of PRACH sweeping operations, repeating the transmission pattern.

In an implementation, the method can further comprise: identifying a best beam, using an enhanced MAC RAR format.

In an implementation, the method can further comprise: identifying a best beam, using PDSCH DMRS's cᵢₙᵢₜ.

In an implementation, the method can further comprise: identifying a best beam, using a PDSCH CRC mask table.

In an implementation, a method comprises: determining a RA-RNTI when a UE has multiple RO locations for transmitting the Msg1 preamble, the UE calculating the RA-RNTI based on a fixed one of the multiple RO locations.

In an implementation, a method comprises: distinguishing a legacy UE and an enhanced UE comprising: separating ROs available for a PRACH repetition and sweeping transmission by an enhanced UE from those available for PRACH transmission by the legacy UE, or separating preambles available for a PRACH repetition and sweeping transmission by the enhanced UE from those available for a PRACH transmission by the legacy UE.

In an implementation, a method comprises: sending, by the UE to the gNB, an N, N being an integer greater than 1, times Msg 1, on N consecutive ROs with a same Tx beam or a plurality of different Tx beams in a RA attempt; and
after the end of the N times transmissions, starting, by the UE, an RAR window, within which the UE monitors all the N RA-RNTIs to receive a network response; and
upon reception of PDCCH scrambled by any one of the N RA-RNTIs within the RAR window, when a RAPID in the RAR message matches with an index of the Msg1 transmitted, determining, by the UE, a successful reception of the RAR from the network.

In an implementation, the method can further comprise:
sending, by the UE to the gNB, the N times Msg 1 on N consecutive ROs on the plurality of different Tx beams;
after the determining, by the UE, of the successful reception of the RAR from the network, determining a best one out of the N transmission beams based on the RA-RNTI scrambling the PDCCH; and
using the best transmission beam for a consequent Msg3 transmission.

In an implementation, the method can further comprise: the gNB attempting to detect all N times transmissions of the Msg 1; upon a successful detection; determining the RA-RNTI corresponding to the RO over which a highest Msg1 signal power was received; and the gNB replying one RA response including an index of the successfully detected Msg1. The method can further comprise: the gNB replying by the method comprising: delivering the PDCCH scrambled by the determined RA-RNTI; and transmitting the RAR message over the PDSCH indicated by a downlink grant included in the PDCCH. The method can further comprise, upon reception of the PDCCH, the UE inferring the index of RO corresponding to the RA-RNTI scrambling the PDCCH, and the UE determining the transmission beam over the RO as the best beam out of the N times transmissions.

### DETAILED DESCRIPTION

Reference is made to Third Generation Partnership Project (3GPP) and the Internet Engineering Task Force (IETF) in accordance with embodiments of the present disclosure. The present disclosure employs abbreviations, terms and technology defined in accord with Third Generation Partnership Project (3GPP) and/or Internet Engineering Task Force (IETF) technology standards and papers, including the following standards and definitions. 3GPP and IETF technical specifications (TS), standards (including proposed standards), technical reports (TR) and other papers are incorporated by reference in their entirety hereby, define the related terms and architecture reference models that follow.

### REFERENCES

[1] 3GPP TS 38.321: v 16.6.0 “NR; Medium Access Control (MAC) protocol specification”. November 2021.
[2] 3GPP TS 38.211: v. 16.7.0 “NR; Physical channels and modulation”. November 2021.
[3] 3GPP TS 38.212: v. 16.7.0 “NR; Multiplexing and channel coding”. November 2021.

### Acronyms

3GPP: Third generation partnership project
BS: Base Station
COTS: Commercial off-the-shelf
C-plane: Control plane
C-RAN: cloud radio access network
CRC: Cyclic Redundancy Check
CU: Central unit
DL: downlink
DMRS: DeModulation Reference Signal
DU: Distribution unit
gNB: g NodeB (applies to NR)
NR: New Radio
MAC: Medium Access Control
MIMO: multiple input, multiple output
O-DU: O-RAN Distributed Unit
O-RU: O-RAN Radio Unit
O-RAN: Open RAN
OPEX: Operating Expense
OTA: Over the Air
PDCCH: Physical Downlink Control Channel
PDSCH: Physical Downlink Shared Channel
PRACH: Physical Random Access Channel
RA: Random Access
RA-RNTI: Random Access-Radio Network Temporary Identity
RACH: Random Access Channel
RAP: Random Access Preamble
RAPID: Random Access Preamble Identifier
RAR: Random Access Response
RLC: Radio Link Control
RO: RACH Occasion
RU: Radio Unit
U-plane: User plane
UE: user equipment
UL: uplink

### Definitions

Channel: the contiguous frequency range between lower and upper frequency limits.

C-plane: Control Plane: refers specifically to real-time control between O-DU and O-RU, and should not be confused with the UE's control plane.

DL: DownLink: data flow towards the radiating antenna (generally on the LLS interface).

LLS: Lower Layer Split: logical interface between O-DU and O-RU when using a lower layer (intra-PHY based) functional split.

O-CU: O-RAN Control Unit-a logical node hosting PDCP, RRC, SDAP and other control functions.

O-DU: O-RAN Distributed Unit: a logical node hosting RLC/MAC/High-PHY layers based on a lower layer functional split.

O-RU: O-RAN Radio Unit: a logical node hosting Low-PHY layer and RF processing based on a lower layer functional split. This is similar to 3GPP's “TRP” or “RRH” but more specific in including the Low-PHY layer (FFT/IFFT, PRACH extraction).

U-Plane: User Plane: refers to IQ sample data transferred between O-DU and O-RU.

UL: Uplink: data flow away from the radiating antenna (generally on the LLS interface).

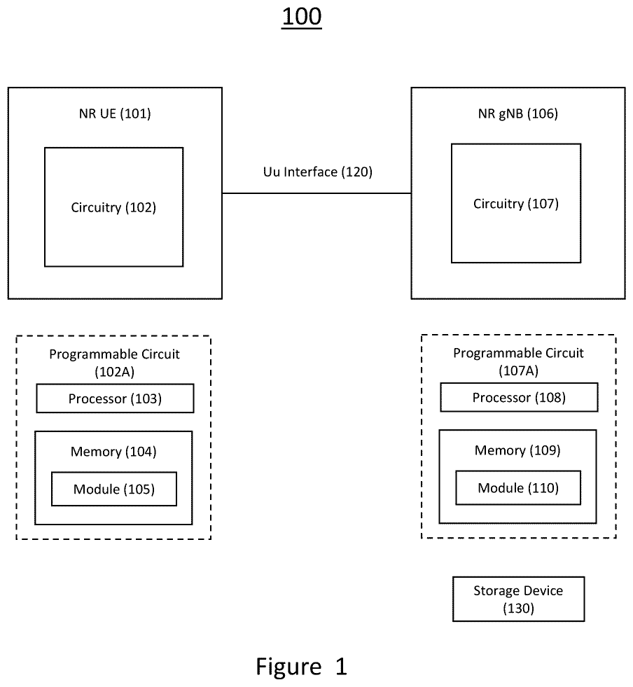

FIG. 1 is a block diagram of a system 100 for implementing the enhancement of reception of RA response. System 100 includes a NR UE 101, a NR gNB 106. The NR UE and the NR gNB are communicatively coupled via a Uu interface 120.

The NR UE 101 includes electronic circuitry, namely circuitry 102, that performs operations on behalf of the NR UE 101 to execute methods described herein. Circuity 102 can be implemented with any or all of (a) discrete electronic components, (b) firmware, and (c) a programmable circuit 102A.

The NR gNB 106 includes electronic circuitry, namely circuitry 107, that performs operations on behalf of the NR gNB 106 to execute methods described herein. Circuity 107 can be implemented with any or all of (a) discrete electronic components, (b) firmware, and (c) a programmable circuit 107A.

Programmable circuit 107A, which is an optional implementation of circuitry 107, includes a processor 108 and a memory 109. Processor 108 is an electronic device configured of logic circuitry that responds to and executes instructions. Memory 109 is a tangible, non-transitory, computer-readable storage device encoded with a computer program. In this regard, memory 109 stores data and instructions, i.e., program code, that are readable and executable by processor 108 for controlling operations of processor 108. Memory 109 can be implemented in a random-access memory (RAM), a hard drive, a read only memory (ROM), or a combination thereof. One of the components of memory 109 is a program module, namely module 110. Module 110 includes instructions for controlling processor 108 to execute operations described herein on behalf of the NR gNB 106.

The term “module” is used herein to denote a functional operation that can be embodied either as a stand-alone component or as an integrated configuration of a plurality of subordinate components. Thus, each of modules 105 and 110 can be implemented as a single module or as a plurality of modules that operate in cooperation with one another.

While modules 110 are indicated as being already loaded into memories 109, and module 110 can be configured on a storage device 130 for subsequent loading into their memories 109. Storage device 130 is a tangible, non-transitory, computer-readable storage device that stores module 110 thereon. Examples of storage device 130 include (a) a compact disk, (b) a magnetic tape, (c) a read only memory, (d) an optical storage medium, (e) a hard drive, (f) a memory unit including multiple parallel hard drives, (g) a universal serial bus (USB) flash drive, (h) a random-access memory, and (i) an electronic storage device coupled to the NR gNB 106 via a data communications network.

Uu Interface (120) is the radio link between the NR UE and the NR gNB, which is compliant to the 5G NR specification [1].

As noted above, to improve the coverage range of PRACH, two possible methods are multiple PRACH transmissions with the same UE Tx beam (“PRACH repetition”) and multiple PRACH transmissions with different UE Tx beams (“PRACH sweeping”). With these methods, the gNB does not know which ROs do or do not need to be combined, or how to determine the locations of ROs. Another problem is how to indicate the best transmission beam to UE in a beam sweeping case.

As per the PRACH specification 3GPP TS 38.211 at the time of the present disclosure, UE selects an SSB above the RSRP threshold, then selects a RAP corresponding to the selected SSB. A UE randomly selects a preamble corresponding to the selected SSB for a contention random access process, and if Msg1 transmission fails, UE can transmit a newly selected preamble again with increased power until UE receives Msg2 from the gNB or UE reaches the configured max power.

If a UE transmits preamble with full power, this causes interference to the other UE, and it does not bring a reception combination to gain. If the UE transmits multiple preambles at the same or different beams and with the same power, this can enhance gNB decoding of Msg1 according to reception combination.

As per the present PRACH specification 3GPP TS 38.211 at the time of the present disclosure, UE selects a beam above the SSB RSRP threshold transmitting preamble, even though it is not the best beam. Msg3 is also transmitted by this beam, which is not beneficial to increase the success rate of the RA process.

If UE transmits multiple preambles at different beams (i.e.: a beam sweeping method) then the gNB can select the best beam according to preamble energy from different beams. When Msg3 is also transmitted by this best beam, this can improve the success rate of the RA process.

Accordingly, described are implementations for existing and future wireless systems that are O-RAN compliant. Implementations as described herein provide enhancement of the 5G PRACH coverage to improve UE access success rate at long distances.

In an implementation, multiple PRACH transmissions in the RA procedure can be helpful for UL coverage enhancement in 5G NR network. As noted above, multiple PRACH (Msg 1) transmissions with a same UE Tx beam are referred to as PRACH repetition; while multiple PRACH (Msg 1) transmissions with different UE Tx beams are referred to as PRACH sweeping.

In case of PRACH repetition, multiple Msg1 (preamble) are transmitted via the same Tx beams on several (e.g. 2,4, or more) consecutive RACH/PRACH occasions (ROs). Based on each of these ROs, one RA-RNTI can be determined according to 5G NR specification [1]. As a result, UE can get multiple RA-RNTIs for this attempt due to multiple Msg1 transmissions. Meanwhile upon the reception of PRACH, the gNB only needs to reply to one Random Access Response (RAR) to the UE although it might detect multiple Msg1 transmissions, in which case the gNB scrambles the PDCCH by one RA-RNTI scheduling the concerned RAR. As such, if the RA-RNTI inferred by the UE is not matched with that used by the gNB to scramble the RAR PDCCH, the UE cannot receive the RAR successfully. The problem is how to assure the RA-RNTI inferred by the UE is aligned with that used to deliver the RAR by the gNB.

In case of PRACH sweeping, multiple Msg1 (preamble), are transmitted on multiple consecutive ROs with different Tx beams. As only one is the best beam for the receiver at this moment, it is beneficial for the gNB to indicate the best beam in RAR. Consequently, the UE can use the best Tx beam to transmit the Msg3 in the following step, which can increase the probability of success for Msg3 reception at the gNB, resulting in improvement of the UL coverage. The problem is that how to indicate the best Tx beam in the RAR message to the UE.

Described are enhancements to a 5G PRACH process, including
Introduction of an RO index calculation for PRACH repetition or/and PRACH sweeping and UE behavior of transmitting the multiple preambles and receiving the RA response;
Separating ROs or preambles to distinguish a legacy UE from an enhanced UE;
A MAC RAR or PDSCH DMRS or PDSCH CRC mask to indicate the best beam.

With the enhancement on the 5G PRACH process as described herein, the following exemplary advantages, objectives and benefits can be achieved:
1. When supporting PRACH repetition or/and sweeping, the gNB can know which ROs to receive and combine. By some parameters and calculations to define some RO locations, the gNB can beneficially receive and combine preambles transmitted multiple times.
2. Because legacy UE can only transmit a preamble once using the same power, but enhanced UE can transmit preambles multiple times using the same power, the gNB can beneficially distinguish legacy UE and enhanced UE. This can be achieved by mapping separate ROs or preambles to legacy UE and enhanced UE respectively.
3. UE can sweep its Tx beam by transmitting multiple Msg.1. Then, the gNB can also determine the best Tx beam and indicate by Msg. 2. This is beneficial for consequent message transmissions during the RACH procedure by using a more appropriate beam.

In an implementation, the gNB can configure a parameter selected from <PRACH repetition, PRACH sweeping, both>, where both means PRACH repetition and PRACH sweeping.

### If the gNB Configures Both, Then Option 1 is as Follows

The gNB can configure the parameters to UE by system information: total number of PRACH repetition and sweeping, first RACH occasion index, RO interval and period.

### Where:

RO interval and period are integers which smaller than or equal to the total number of RO in a PRACH period that obtained by PRACH configuration index and period should be larger than or equal to total number of PRACH repetition and sweeping.
RO interval means the interval between PRACH repetition/sweeping in a RACH repetition/sweeping set.
Period means the interval between PRACH repetition/sweeping sets in the PRACH period.

According to these parameters, UE can determine the RO by the following formula from candidate ROs, which is obtained by the PRACH configuration index. The following RACH occasion index is used to transmit repetitive preamble with the same beam or different beams:
RACH occasion index [m, n]=first RACH occasion index+n*period+m* RO interval, where n is from 0,1,2 . . . to (┌total number of RO in PRACH period/period ┐−1), m is from 0,1,2 . . . to (total number of PRACH repetition and sweeping−1).
The UE should perform PRACH sweeping first in a repetition/sweeping set, and if there still are available ROs by above formula calculation, then repeat previous transmitting pattern.

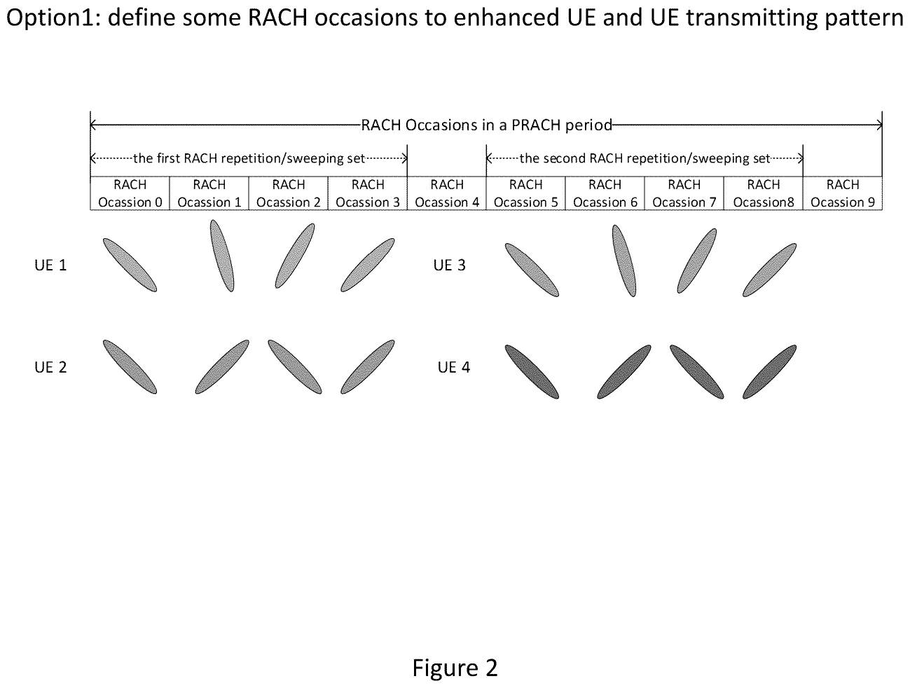

For example, in an implementation, the gNB configures total number of PRACH repetition and sweeping is 4. First RACH occasion is 0. RO interval is 1. Period is 5. And total number of RO in a PRACH period is 10. As shown in FIG. 2, the available ROs for PRACH repetition/sweeping are following:
The available ROs in the first PRACH repetition/sweeping set:
   The RO index of first repetitive transmission: RACH occasion index [0,0]=0
   The RO index of second repetitive transmission: RACH occasion index [1,0]=1
   The RO index of third repetitive transmission: RACH occasion index [2,0]=2
   The RO index of fourth repetitive transmission: RACH occasion index [3,0]=3
The available ROs in the second PRACH repetition/sweeping set:
   The RO index of first repetitive transmission: RACH occasion index [0,1]=5
   The RO index of second repetitive transmission: RACH occasion index [1,1]=6
   The RO index of third repetitive transmission: RACH occasion index [2,1]=7
   The RO index of fourth repetitive transmission: RACH occasion index [3,1]=8

In the first PRACH repetition/sweeping set, UE1, which has four beams, performs PRACH sweeping with four beams. UE2, which has two beams, performs PRACH sweeping with two beams firstly, then repeats the transmitting pattern at the remaining two ROs.

In the second PRACH repetition/sweeping set, UE3, which has four beams, performs PRACH sweeping with four beams. UE4 which has two beams performs PRACH sweeping with two beams first, then repeats the transmitting pattern at the remaining two beam ROs.

Because UE has multiple RO locations for transmitting a preamble, UE can calculate the RA-RNTI based on fixed one among the multiple RO locations (e.g., the first one or the last one among the multiple RO locations).

### If the gNB Configures Both, Then Option 2 is as Follows

The gNB can configurate these parameters to UE by system information: the number of PRACH repetition and the number of PRACH sweeping, first RACH occasion index, RO interval and period.

According to these parameters, UE can determine the RO from candidate ROs by following formula, which is obtained by a PRACH configuration index.

The following RACH occasion index is used to transmit repetitive preamble with same beam or different beams.

RACH occasion index [m, n]=first RACH occasion index+n*period+m* RO interval, where n is from 0,1,2 . . . to (┌total number of RO in RO period/period┐−1), m is from 0,1,2 . . . to (total number of PRACH repetition and sweeping−1), where total number of PRACH repetition and sweeping is the number of PRACH repetition multiply by the number of PRACH sweeping.

The UE first performs PRACH repetition, and then performs PRACH sweeping. If UE does not support PRACH sweeping, or the number of beams less than the number of PRACH sweeping, then the previous transmitting pattern is repeated.

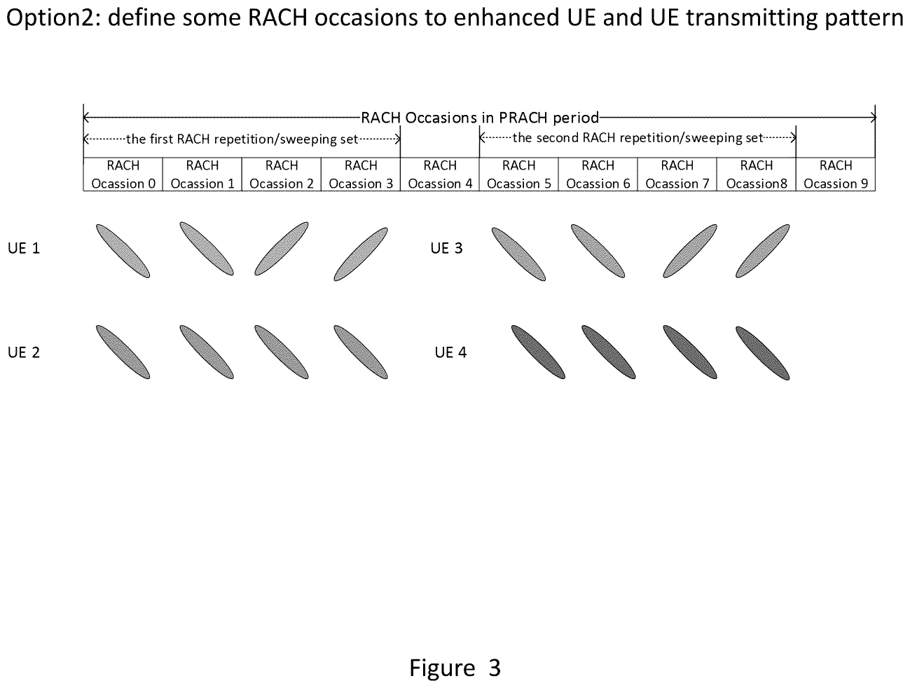

For example, the gNB is configured so that the number of PRACH repetition is 2. The number of PRACH sweeping is 2. First RACH occasion is 0. RO interval is 1. The period is 5. Also, total number of RO in RO period is 10. As shown in FIG. 3, the available ROs are as follows:

The available ROs in the first PRACH repetition/sweeping set:
The RO index of first repetitive transmission: RACH occasion index [0,0]=0
The RO index of second repetitive transmission: RACH occasion index [1,0]=1
The RO index of third repetitive transmission: RACH occasion index [2,0]=2
The RO index of fourth repetitive transmission: RACH occasion index [3,0]=3
   The available ROs in the second PRACH repetition/sweeping set:
The RO index of first repetitive transmission: RACH occasion index [0,1]=5
The RO index of second repetitive transmission: RACH occasion index [1,1]=6
The RO index of third repetitive transmission: RACH occasion index [2,1]=7
The RO index of fourth repetitive transmission: RACH occasion index [3,1]=8

In the first PRACH repetition/sweeping set, UE1, which has 2 beams first performs repetition twice with the same beam, then transmits the preamble with a different beam and performs repetition twice. UE2, which has 1 beam, first performs repetition twice with a beam. Due to no other available beams, the transmitting pattern is then repeated (i.e.: continues to perform repetition twice).

In the second PRACH repetition/sweeping set, UE3, which has 2 beams, first performs repetition twice at the same beam, then transmits the preamble at a different beam and performs repetition twice. UE4. which has 1 beam, first performs repetition twice with a beam. As above, with no other available beams, the transmitting pattern is repeated twice.

### If the gNB Configures PRACH Repetition, Then

The gNB can configure the parameters to the UE by system information: the number of PRACH repetition or total number of PRACH repetition and sweeping which means the number of PRACH repetition, first RACH occasion index, RO interval and period.

The RACH occasion index is calculated which is the same with both.

The difference from both is that UEs only perform PRACH repetition.

### If the gNB Configures PRACH Sweeping, Then

The gNB can configure these parameters to the UE by system information: the number of PRACH sweeping or total number of PRACH repetition and sweeping which means the number of PRACH sweeping, first RACH occasion index, RO interval and period.

RACH occasion index is calculated which is the same with both.

The difference from both is UEs try to perform PRACH sweeping. If the number of beams less than PRACH sweeping, then the transmitting pattern is repeated.

### Two Options to Distinguish Legacy UE and Enhanced UE (i. e. Supporting PRACH Repetition and/or PRACH Sweeping)

### Option 1: by RO to Distinguish

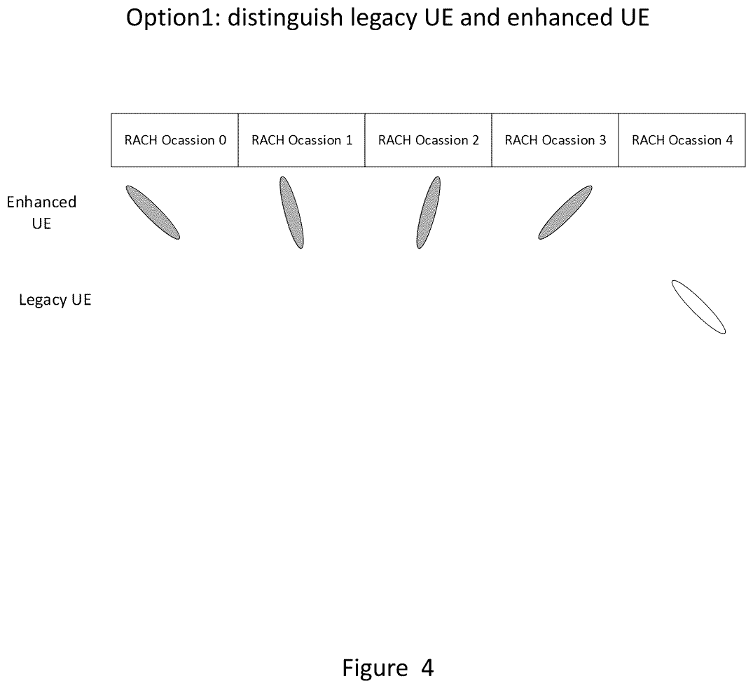

The available ROs used for PRACH repetition and sweeping are not used for legacy UEs—UEs that do not support PRACH repetition and sweeping. For example, as shown in FIG. 4, where an enhanced UE transmits preamble at RO0/RO1/RO2/RO3, a legacy UE can only transmit preamble at RO4.

### Option 2: by Preamble to Distinguish

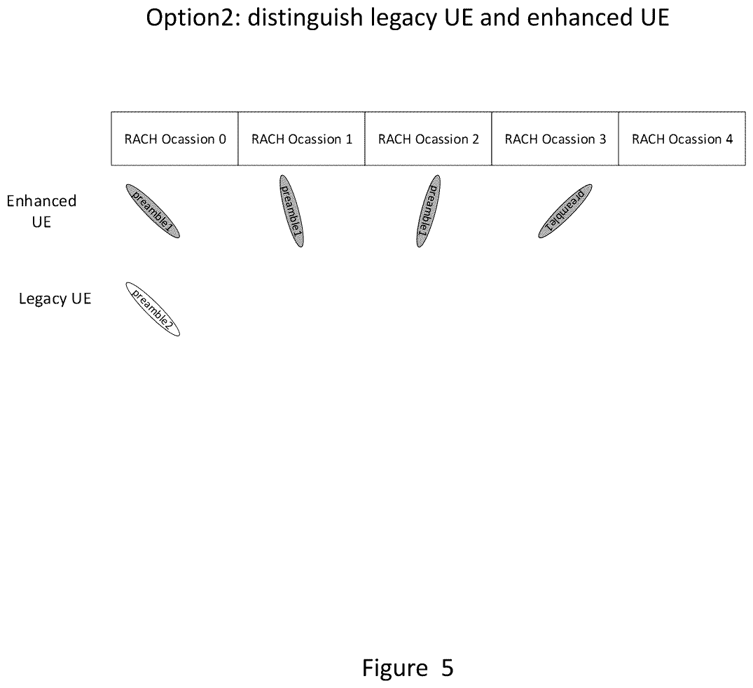

The preambles used for PRACH repetition and sweeping by enhanced UEs are not used for RACH initiated by legacy UEs. For example, as shown in FIG. 5, enhanced UE transmits a preamble1 at RO0/RO1/RO2/RO3, the legacy UE can transmit a preamble except for pramble1 at the same RO.

### If the gNB Configures a Parameter as Both or PRACH Sweeping, Then This Indicates the Best Beam to the UE Which Has Three Options

### Option 1: by MAC RAR to Indicate

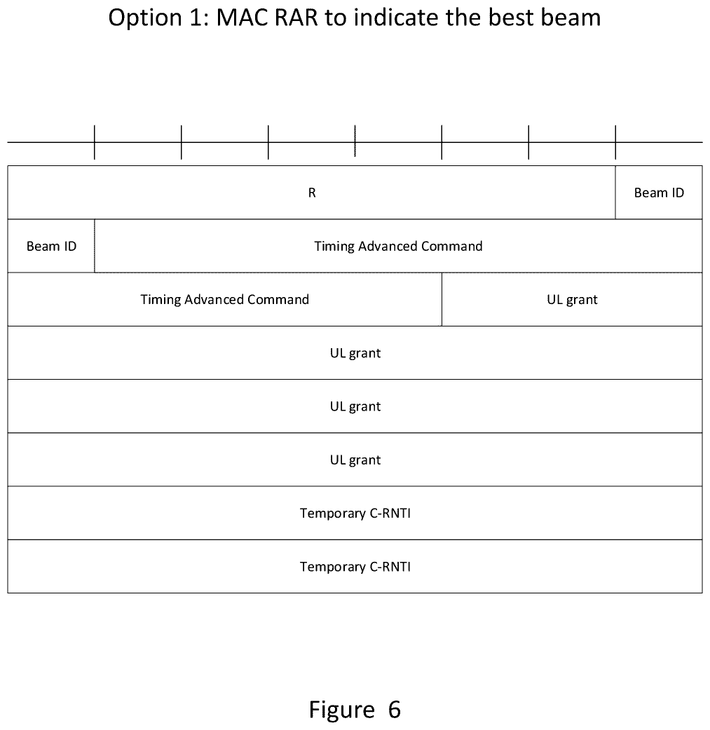

As shown in FIG. 6, a new MAC RAR format is defined and used to indicate the best beam. A beam ID is added to MAC RAR, which can be 2 bits or larger than 2 bits, which depends on the maximum number of UEs' beams.

Option 2: by PDSCH (msg2) DMRS to Indicate

A pseudo-random sequence generator can be initialized with

$${c}_{i n i t} = ( {2}^{17 + n} ( {N}_{s y m b}^{slot} {n}_{s , f}^{μ} + l + 1 ) ( 2 {N}_{ID}^{{\overline{n}}_{SCID}^{\overline{λ}}} + 1 ) + {2}^{17 + n} ⌊ \overline{\frac{λ}{2}} ⌋ + {2}^{1 + n} {N}_{ID}^{{\overline{n}}_{SCID}^{\overline{λ}}} + {2}^{n} {\overline{n}}_{S C I D}^{\overline{λ}} + β * {N}_{ID}^{b e a m} ) mod {2}^{31}$$

where N_{1D}^{beam} is added to cᵢₙᵢₜ and indicates the best beam index receiving the preamble, where n=[log₂ M] and M is the number of beams.

When a UE does not support PRACH repetition/sweeping, or the gNB does not configure a PRACH repetition/sweeping, n=0 and B=0.

Option 3: by PDSCH (msg2) CRC Mask to Indicate

The parity bits are computed and attached to the PDSCH transport block setting L to 16 bits or 24 bits. After the attachment, the CRC bits are scrambled according to the gNB transmits beams configuration with the <x_{beam,0}, x_{beam,1}, . . . , x_{beam,L}> as indicated in Table 1, assuming there are four beams. Table 2 show M beams.

TABLE 1
CRC mask for PDSCH (msg2) Transport Blocks

| Index of | PDSCH (msg2) CRC mask |
|---|---|
| transmit beams | <x_{beam,0}, x_{beam,1}, . . . , x_{beam,L}> |
| 0 | <0, 0, 0, 0, 0, 0, 0, 0, 0, 0, 0, 0, 0, 0, 0, 0> |
| 1 | <1, 1, 1, 1, 1, 1, 1, 1, 1, 1, 1, 1, 1, 1, 1, 1> |
| 2 | <1, 0, 1, 0, 1, 0, 1, 0, 1, 0, 1, 0, 1, 0, 1, 0> |
| 3 | <0, 1, 0, 1, 0, 1, 0, 1, 0, 1, 0, 1, 0, 1, 0, 1> |

TABLE 2
CRC mask for PDSCH (msg2) Transport Blocks

| Index of | PDSCH (msg2) CRC mask |
|---|---|
| transmit | <x_{beam,0}, x_{beam,1}, . . . , |
| beams | x_{beam,log}_{₂} _{M, . . .} x_{beam,L}> |
| 0 | <0, 0, . . . , 0, . . . > |
| 1 | <1, 1, . . . 1, . . . > |
| 2 | <1, 0, . . . 0, . . . > |
| 3 | <0, 1, . . . 1, . . . > |
| . . . | . . . |
| M-1 | <0, 0, . . . 1, . . . > |

In another implementation, an enhancement of RAR reception for the case of multiple Msg1 transmissions (preamble) are transmitted on multiple consecutive ROs with either same Tx beams or different Tx beams in NR RA procedure.

As per the current 5G NR specification [1], the UE transmits one Msg1 (preamble) on a RO before starting an RAR window when initiating a random access attempt. If the gNB can detect the Msg1 successfully then a RAR message is delivered to the UE, and the PDCCH scheduling the RAR is scrambled by the RA-RNTI. The PDDCH is scrambled by the RA-RNTI based on the time-frequency domain location of the RO on which the Msg1 is transmitted according to the formula below in the 5G NR specification [1].

$$RA - RNTI = 1 + s\_id + 14 \times t\_id + 14 \times 80 \times f\_id + 14 \times 80 \times 8 \times ul\_carrier \_id$$

where s_id is the index of the first OFDM symbol of the PRACH occasion (0≤s_id<14), t_id is the index of the first slot of the PRACH occasion in a system frame (0≤t_id<80), where the subcarrier spacing to determine t_id is based on the value of μ specified in clause 5.3.2 in TS 38.211 [2], f_id is the index of the PRACH occasion in the frequency domain (0≤f_id<8), and ul_carrier_id is the UL carrier used for RAP transmission (0 for NUL carrier, and 1 for SUL carrier).

Since in a RA attempt only one Msg1 is transmitted on one RO, the RA-RNTI inferred by the UE is same as that determined by the gNB so there is no misalignment problem on RA-RNTI between UE and the gNB.

Further, since there is only one Msg1 transmission in a RA attempt, there is no opportunity for the network to indicate the UE which Tx beam is the best. As a result, the UE can only randomly select one Tx beam (if UE is capable to utilize multiple Tx beams) to transmit the Msg3 in the later step.

Accordingly, described is an enhancement for a RACH procedure in 5G NR, including on the reception of RA response. Implementations as described herein include:

When N (N>1) times Msg1 (preamble) are transmitted on N consecutive ROs in a RA attempt, the UE monitors N RA-RNTIs within an RAR window, and each RA-RNTI is calculated based on the time-frequency location of each individual RO. Upon reception of PDCCH scrambled by anyone of these N RA-RNTIs within the RAR window, the RAPID in the RAR message matches with the index of the preamble transmitted, then the UE determines successful reception of RAR from network.

In case of PRACH repetition, that is N times Msg1 (preamble) transmitted with same Tx beam by the UE, the gNB tries to detect all N times transmissions and then delivers the PDCCH scrambled by the RA-RNTI calculated based on the RO over which the highest signal power of Msg1 was received.

In case of PRACH sweeping, that is N times Msg1 (preamble) are transmitted with different Tx beams by the UE, the gNB tries to detect all N times transmission and determines the best Tx beam (for Msg1 transmission) based on the signal power of each individual Msg1, and then delivers the PDCCH scrambled by the RA-RNTI corresponding to the RO over which the best Tx beam was detected. Upon reception of PDCCH, based on the RA-RNTI scrambling the PDCCH the UE determines the best Tx beam in the N times Msg1 transmissions and then uses the best Tx beam for the Msg3 transmission.

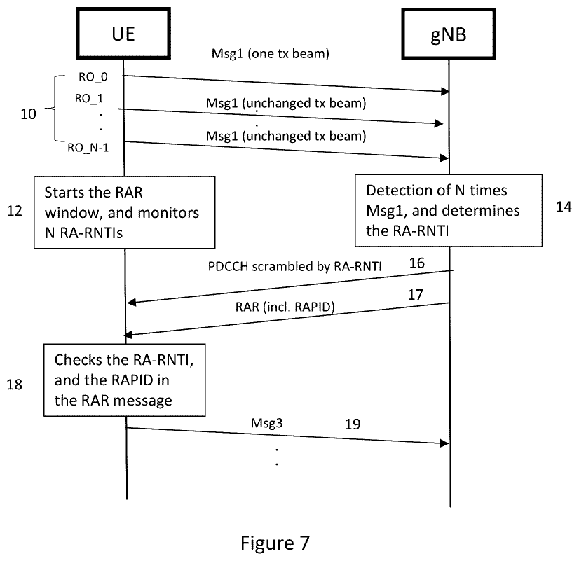

FIG. 7 shows an implementation of multiple Msg1 transmissions with same Tx beam. At block 10, the UE transmits N times Msg1 (preamble) on N consecutive ROs with the same Tx beam in a RA attempt by the UE. After the end of the N times transmissions, at block 12 the UE starts the RAR window, and in the window the UE monitors all the N RA-RNTIs to receive the response from the network. Each RA-RNTI is calculated based on the time-frequency location of each individual RO as per specification [1]. At block 14, the gNB attempts to detect all the N times Msg1 transmissions, and upon the successful detection result, determines the RA-RNTI corresponding to the RO over which the highest Msg1 signal power was received.

At block 16, the gNB replies one RAR for the successfully detected preamble by delivering a PDCCH scheduling the RAR addressed to the RA-RNTI and scrambling the PDCCH with the RA-RNTI determined in step 14. At block 17, the gNB transmits the RAR message including the RAPID over PDSCH as indicated by the downlink grant included in the PDCCH. At block 18, the UE decodes the PDCCH scrambled by RA-RNTI in the RAR window and then receives and checks the RAR message according to the DL grant in the concerned PDCCH. If the RAPID included in the RAR message matches the index of the preamble transmitted at block 10, the UE determines successful reception of the RA response from the network. At block 19, the UE sends a Msg3 transmission on the Tx beam.

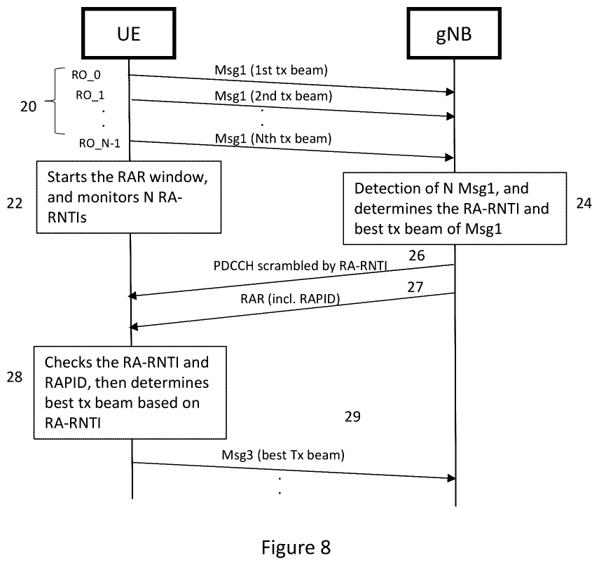

FIG. 8 shows an implementation of multiple Msg1 transmissions with different Tx beams. At block 20, the UE transmits N times Msg1 (preamble) on N consecutive ROs with different Tx beams in a RA attempt by the UE. After the end of the N times transmissions, at block 22, the UE starts the RAR window, and in the window the UE monitors all the N RA-RNTIs to receive the response from the network. Each RA-RNTI is calculated based on the time-frequency location of each individual RO as per specification [1]. At block 24, the gNB attempts to detect all the N times Msg1 transmissions, determines the best Tx beam (for Msg1 transmission) based on the signal power of each individual Msg1, and upon the successful detection result, determines the RA-RNTI corresponding to the RO over which the best Tx beam was detected.

At block 26, the gNB replies one RAR for the successfully detected preamble by delivering a PDCCH scheduling the RAR addressed to the RA-RNTI and scrambling the PDCCH with the RA-RNTI determined in step 14. At block 27, the gNB transmits the RAR message including the RAPID over PDSCH as indicated by the downlink grant included in the PDCCH. At block 28, the UE decodes the PDCCH scrambled by RA-RNTI in the RAR window and then receives and checks the RAR message according to the DL grant in the concerned PDCCH. If the RAPID included in the RAR message matches the index of the preamble transmitted at block 20, the UE determines successful reception of the RA response from the network. For PRACH sweeping, as the N times Msg1 transmitted with different Tx beams in block 20, the UE can determine the best one out of the N transmission beams based on the RA-RNTI scrambling the PDCCH at block 26, i.e. inferring the index of RO based on the RA-RNTI, while the RO index is identical to index of Tx beam. At block 29, the UE uses the best Tx beam for a Msg3 transmission.

With the enhancement of the RACH procedure described above, an exemplary advantage includes avoiding a potential mismatch of RA-RNTI(s) inferred by UE and that was used by the gNB to scramble the PDCCH. In the case of PRACH sweeping, the gNB can indicate the best Tx beam implicitly via the RAR message, which can then be used by UE for Msg3 transmission improving the RA success probability in the NR network.

It will be understood that implementations and embodiments can be implemented by computer program instructions. These program instructions can be provided to a processor to produce a machine, such that the instructions, which execute on the processor, create ways for implementing the actions specified herein. The computer program instructions can be executed by a processor to cause a series of operational steps to be performed by the processor to produce a computer-implemented process such that the instructions, which execute on the processor to provide steps for implementing the actions specified. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the disclosure.

1. A method comprising:
providing a g NodeB (gNB) with parameters the gNB employs to configure system information for a Physical Random Access Channel (PRACH) sweeping and repetition operation, the gNB parameters comprising:
a total number of PRACH repetition and sweeping,
a first Random Access Channel (RACH) occasion index,
a RACH Occasion (RO) interval and period,
a number of PRACH repetition, and
a number of PRACH sweeping.

2. The method of claim 1, further comprising:
determining, using one or more of the parameters, multiple ROs' location by a user equipment (UE) for the PRACH sweeping and repetition operation.

3. The method of claim 2, the determination comprising:
the RACH occasion index [m, n]=first RACH occasion index+n*period+m* the RO interval, where n is from 0,1,2 . . . to (the (┌total number of RO in PRACH period/period┐−1), m is from 0,1,2 . . . to (the total number of PRACH repetition and sweeping−1); or
the RACH occasion index [m, n]=first RACH occasion index+n*period+m* RO interval, where n is from 0,1,2 . . . to (┌total number of RO in RO period/period ┌−1), m is from 0,1,2 . . . to (the total number of PRACH repetition and sweeping−1), where the total number of PRACH repetition and sweeping is the number of PRACH repetition multiplied by the number of PRACH sweeping.

4. The method of claim 2, further comprising wherein a UE behavior for transmitting a Msg1 preamble for the PRACH sweeping and repetition operation comprises, if configuration by the gNB is both PRACH sweeping and repetition:
the UE first performing a PRACH sweeping operation in a repetition and sweeping set, and if there still are available ROs, then repeating a previous transmission pattern; or
the UE first performing a number of PRACH repetition operations, next performing a number of PRACH sweeping operations, and if (i) the UE does not support PRACH sweeping or (ii) a number of beams is less than the number of PRACH sweeping operations, then repeating a previous transmission pattern.

5. The method of claim 1, further comprising a UE behavior for transmitting a Msg1 preamble for the PRACH sweeping and repetition operation, which comprises:
if configuration by the gNB is PRACH repetition, a UE performs only the PRACH repetition operation.

6. The method of claim 1, further comprising a UE behavior for transmitting a Msg1 preamble for the PRACH sweeping and repetition operation, which comprises:
if configuration by the gNB is PRACH sweeping, a UE attempting PRACH sweeping, and if a number of beams less than the number of PRACH sweeping operations, repeating the transmission pattern.

7. The method of claim 1, further comprising:
identifying a best beam, using an enhanced Medium Access Control (MAC) Random Access Response (RAR) format.

8. The method of claim 1, further comprising:
identifying a best beam, using Physical Downlink Shared Channel (PDSCH) DeModulation Reference Signal (DMRS)'s cᵢₙᵢₜ.

9. The method of claim 1, further comprising:
identifying a best beam, using a Physical Downlink Shared Channel (PDSCH) Cyclic Redundancy Check (CRC) mask table.

10. A method determining a Random Access-Radio Network Temporary Identity (RA-RNTI), comprising:
when a UE has multiple RO locations for transmitting the Msg1 preamble, the UE calculates the RA-RNTI based on a fixed one of the multiple RO locations.

11. A method of distinguishing a legacy user equipment (UE) and an enhanced UE comprising:
separating ROs available for a Physical Random Access Channel (PRACH) repetition and sweeping transmission by the enhanced UE from those available for PRACH transmission by the legacy UE, or
separating preambles available for a PRACH repetition and sweeping transmission by the enhanced UE from those available for a PRACH transmission by the legacy UE.

12. A method of reception of RA response in NR network, comprising:
sending, by a user equipment (UE) to a gNodeB (gNB), an N (N being an integer greater than 1) times Msg 1, on N consecutive Random Access Channel (RACH) Occasion (ROs) with a same Tx beam or a plurality of different Tx beams in a (Random Access) RA attempt; and
after the end of the N times transmissions, starting, by the UE, an Random Access Response (RAR) window, within which the UE monitors all the N Random Access Radio Network Temporary Identities (RA-RNTIs) to receive a network response; and
upon reception of a Physical Downlink Control Channel (PDCCH) scrambled by any one of the N RA-RNTIs within the RAR window, when a random access preamble identifier (RAPID) in the RAR message matches with an index of the Msg1 transmitted, determining, by the UE, a successful reception of the RAR from the network.

13. The method of claim 12, further comprising:
sending, by a user equipment (UE) to a gNodeB (gNB), the N times Msg 1 on N consecutive ROs on the plurality of different Tx beams;
after the determining, by the UE, of the successful reception of the RAR from the network, determining a best one out of the N transmission beams based on the RA-RNTI scrambling the PDCCH; and
using the best transmission beam for a consequent Msg3 transmission.

14. The method of claim 13, wherein:
the gNB attempting to detect all N times transmissions of the Msg 1;
upon a successful detection; determining the RA-RNTI corresponding to the RO over which a highest Msg1 signal power was received; and
the gNB replying one RA response including an index of the successfully detected Msg1.

15. The method of claim 14, wherein the gNB replies by the method comprising:
delivering the PDCCH scrambled by the determined RA-RNTI; and
transmitting the RAR message over a Physical Downlink Shared Channel (PDSCH) indicated by a downlink grant included in the PDCCH.

16. The method of claim 15, further comprising:
upon reception of the PDCCH, the UE inferring the index of RO corresponding to the RA-RNTI scrambling the PDCCH, and
the UE determining the transmission beam over the RO as the best beam out of the N times transmissions.
